(19) United States
(12) Patent Application Publication
(10) Pub. No.: US 2009/0262792 A1
(43) Pub. Date: Oct. 22, 2009

(54) DEVICE, SYSTEM AND METHOD FOR MEASURING SIGNALS

(75) Inventors: Chunxing Huang, Shenzhen (CN); Daochun Mo, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/492,997

(22) Filed: Jun. 26, 2009

Related U.S. Application Data
(63) Continuation of application No. PCT/CN2007/071281, filed on Dec. 20, 2007.

(30) Foreign Application Priority Data
Dec. 28, 2006 (CN) 200610132387.1

(51) Int. Cl. H04B 17/00

(52) U.S. Cl. 375/224

(57) ABSTRACT

A system for measuring signals includes: a simulating device, adapted to simulate equalization for an incoming signal of an SERDES receiving chip and generate a response signal, and a feature output device, adapted to output the feature information of the response signal. The invention also discloses a method and a device for measuring signals.

This application is a continuation of International Patent Application No. PCT/CN2007/071281, filed on Dec. 20, 2007, titled “Device, System and Method for Measuring Signals”, which claims the priority of Chinese Patent Application No. 200610132387.1, filed on Dec. 28, 2006, titled “Device, System and Method for Measuring Signals,” the contents of both of which are incorporated herein by reference in their entireties.

### FIELD OF THE INVENTION

The present disclosure relates to the field of communication technologies and in particular to a device, a system, and a method for measuring signals.

### BACKGROUND OF THE INVENTION

Currently, with the development of the high-speed serial link technology, a practical method for overcoming the contradiction between the data transmission rate and the transmission channel bandwidth as well as signal deterioration due to the loss of channel is to apply proper signal processing technologies (for example, signal pre-emphasis technology at the data transmitter, and signal equalizing technology at the data receiver) inside an information transceiver chip such as serializer/deserializer (SERDES).

Generally, the signal pre-emphasis technology uses a pre-emphasis circuit to manually enhance the high-frequency component of transmitter signals in view of the low-pass feature of the channel. Accordingly, at the receiver, a similar processing technology can be used to enhance the high-frequency component of signals. Generally, mature signal equalizing technologies include: Linear Feed-forward Equalizer (LFE), Decision Feed-back Equalizer (DFE), and Continuous Time Equalizer (CTE). For the signals processed through a signal equalizing technology at the receiver, the measurement of the signal characteristics is based on a test system shown in FIG. 1. The test system performs sampling of the received equalized signals, and displays the sampled signals onto a computer through an interface. The waveforms of the signals are displayed through an eye pattern, a bathtub curve, and so on. The process is described below:

The SERDES chip 10 receives an incoming signal to be equalized through an equalizer 11 to obtain an equalized response signal. The in-chip oscilloscope 12 performs Clock and Data Recovery (CDR) for the response signal to adjust the offset component of the sampling location, thus the waveforms of the response signals can be sampled accurately. The in-chip oscilloscope 12 communicates with the computer 13 through an Input and Output (IO) interface, thus the waveforms of the response signals can be displayed on the computer 13.

However, the technology for implementing the aforementioned in-chip oscilloscope is complex, and the SERDES chip occupies a wide space on the Printed Circuit Boards (PCBs). Moreover, extra interface pins are required between the in-chip oscilloscope and the computer, thus many pin resources can be occupied.

In the system for testing signal in the prior art, the waveform information of equalized signals is collected by an oscilloscope built in an SERDES chip, and the waveform information is displayed by a computer outside the chip. Therefore, the costs of designing and manufacturing SERDES chips are increased.

### SUMMARY OF THE INVENTION

An embodiment of the present disclosure provides a system, a method, and a device for measuring equalized signals outside an SERDES receiving chip, thus reduce the costs of designing and manufacturing the oscilloscope built in an SERDES chip.
A system for measuring signals includes:
a simulating device, adapted to obtain the incoming signal to be equalized by an SERDES chip, simulate equalization for the incoming signal, and generate a response signal; and
a signal feature outputting device, adapted to output the feature information of the response signal.
A method for measuring signals includes:
obtaining the incoming signal to be equalized by an SERDES chip;
simulating equalization of the SERDES chip for the incoming signal, and generating a response signal; and
outputting the feature information of the response signal.

A device for measuring signals includes:
a simulating unit, adapted to obtain the incoming signal to be equalized by an SERDES chip, simulate equalization for the incoming signal, and generate a response signal; and
a signal feature outputting unit, adapted to output the feature information of the response signal.

Through a simulating device which simulates the SERDES chip to equalize the incoming signal, and through a signal feature output device which outputs the feature information of the response signal processed by the simulating device, the system, method and device under the present disclosure measure the equalized signals outside the SERDES chip and reduce the costs of designing and manufacturing the oscilloscope built in the SERDES chip.

### BRIEF DESCRIPTION OF THE DRAWINGS

FIG. 1 is a block diagram of a signal measurement system in the prior art;

FIG. 2 is a block diagram of an embodiment of a signal measurement system;

FIG. 3 is a block diagram of an embodiment of a signal measurement system;

FIG. 4 is a block diagram of an embodiment of a signal measurement system;

FIG. 5 is a block diagram of an embodiment of a signal measurement system;

FIG. 6 is a flowchart of an embodiment of a method for measuring signal;

FIG. 7 is a flow chart of an embodiment of a method for measuring signal;

FIG. 8 is a flow chart of an embodiment of a method for measuring signal;

FIG. 9 is a flow chart of an embodiment of a method for measuring signal;

FIG. 10 is a flow chart of the fourth embodiment of a method for measuring signal;

FIG. 11 is a block diagram of an embodiment of a signal measurement device;

FIG. 12 is a block diagram of an embodiment of a signal measurement device;

FIG. 13 is a block diagram of an embodiment of a signal measurement device;

FIG. 14 is a block diagram of an embodiment of a signal measurement device;

FIG. 15 is a block diagram of an embodiment of the method of equalization based on an LFE model;

FIG. 16 is a block diagram of an embodiment of the method of equalization based on a DFE model;

FIG. 17 is a flow chart of an embodiment of the method of equalization based on the frequency response characteristics;

FIG. 18 is a block diagram of an embodiment of method of equalization based on an IBIS model; and

FIG. 19 is a flow chart of an embodiment of the method of CDR.

### DETAILED DESCRIPTION OF THE INVENTION

Embodiments of the present disclosure provides a system, a method, and a device for measuring signals after the signals are equalized outside an SERDES chip capable of equalizing signal, thus reduce the costs of the solution of design and manufacturing for measuring the signals which are equalized inside an SERDES chip.

The embodiments of the invention will be described in details with reference to drawings.

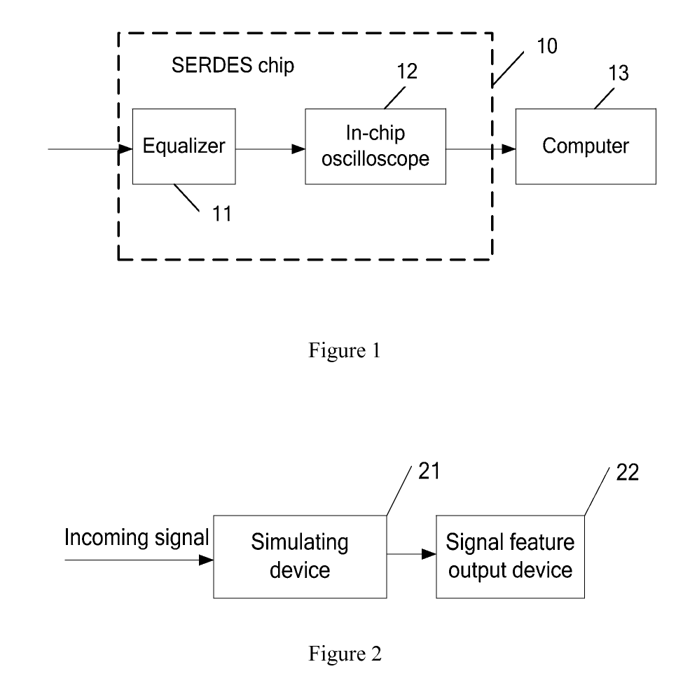

FIG. 2 shows the structure of an embodiment of a system for measuring signals. The embodiment of a system for measuring signal includes a simulating device 21 and a signal characteristic output device 22. The connection relationship between the devices (21, 22) and functions of the devices (21, 22) are described below:

The simulating device 21 is connected with the signal characteristic output device 22;

The simulating device 21 is adapted to obtain an incoming signal, simulate equalization for the incoming signal, and generate a response signal. The simulating device 21 may apply the method of equalization in the SERDES receiving chip; in other words, the simulating device 21 may use an equalizer model which is the same as the equalizer model in the SERDES receiving chip (for example, the aforementioned one or a combination of LFE, DFE and CTE equalizer formula models, or a model with the equalizer frequency response characteristics) to equalize the incoming measured signal, generate an equalized signal as a response signal, and output the response signal to the signal characteristic output device 22; and

The signal characteristic output device 22 is adapted to output the feature information of the response signal; for example, the signal characteristic output device 22 may display the features information of the equalized signal. The feature information of an equalized signal may be displayed in the form of signal time domain waveforms, eye diagrams, statistic eye diagrams, or bathtub curves. Therefore, the signal characteristic output device 22 may be an oscilloscope or any other display device.

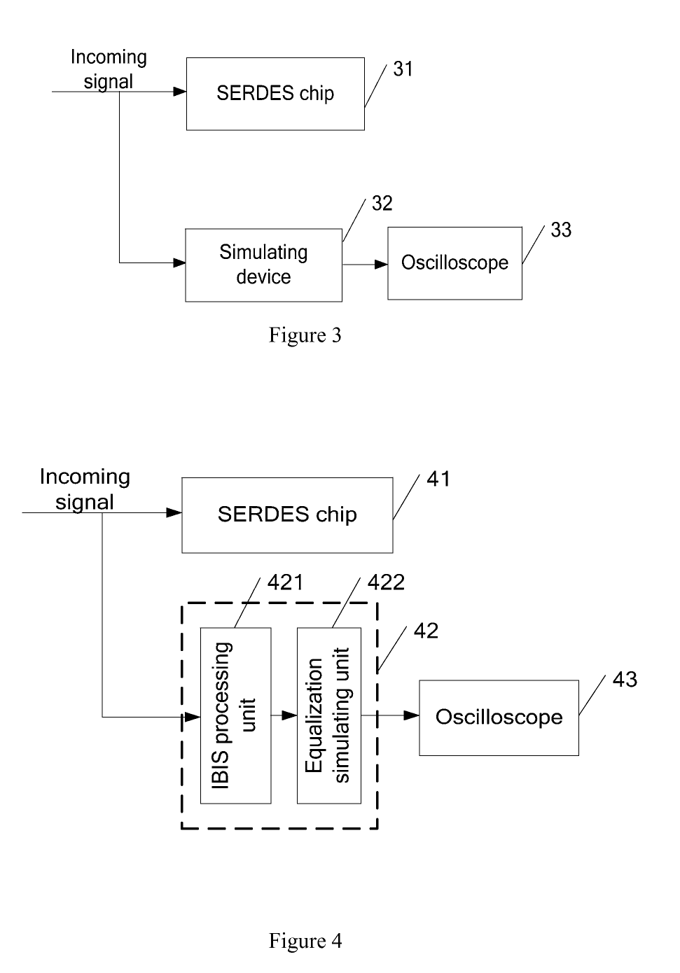

FIG. 3 shows the structure of an embodiment of a system for measuring signal, supposing that the system includes an SERDES receiving chip, an oscilloscope, and a simulating device for simulating the equalization circuit in the SERDES receiving chip. The signal measurement system includes: an SERDES receiving chip 31, a simulating device 32, and an oscilloscope 33. The connection relation and the functions of the devices are described below:

The SERDES receiving chip 31 is connected with the simulating device 32, and the simulating device 32 is connected with the oscilloscope 33.

The simulating device 32 is applied in two scenarios under the embodiment of the present disclosure:

Scenario 1:

The simulating device 32 is adapted to simulate equalization for the incoming signal in one or a combination of the LFE mode, DFE mode, and CTE mode. In the practical implementation, the models corresponding to the equalization modes are described below:
1. LFE model:

The LFE model is used to simulate the equalization function of the LFE circuit in the SERDES receiving chip 31. The LFE model may be expressed by the following filter formula:

V(T₀)=W₁*Vᵢₙ(T₀)+W₂*Vᵢₙ(T₋₁)+ . . . +W_{N}*Vᵢₙ(T_{N-1});

wherein, Wᵢ (i=1, . . . , N) is a coefficient on different orders corresponding to the LFE;
Vᵢₙ(Tᵢ) (i=0, . . . , N-1) is a waveform on different orders corresponding to the input signal.

According to the above formula, a Finite Impulse Response (FIR) filter structure includes a shift register group, a coefficient group W, a multiplier, and an adder. FIG. 15 is a block diagram of equalization based on an LFE model in an embodiment of the present disclosure. In this LFE model, the shift register group inputs all or part of the incoming signals and performs N-order delay (N is a serial number of order of the LFE model). When the SERDES receiving chip 31 equalizes in such a mode, the order “N” may be the same as the order of the shift register in the SERDES receiving chip 31. The delay T is the reciprocal of the signal baud rate, and the FIR filter multiplies the coefficient group W by the voltage signal stored in the shift register group to obtain a product, and adds up the products in all groups to obtain the final output signal. The final output signal may serve as a response signal or part of a response signal.
2. DFE model:

The DFE model is used to simulate the equalization function of the DFE circuit in the SERDES receiving chip 3 1. The DFE model may be expressed by the following filter formula:

V(T₀)=Vᵢₙ(T₀)−W₁*D(T₋₁)−W₂*D(T₋₂)- . . . -W_{N}*D(T_{-N});

wherein, Wᵢ (i=1, . . . , N) is a coefficient on different orders corresponding to the DFE;
Vᵢₙ(T₀) is the waveform of the currently input signal;
D(T₋ᵢ) (i=1, . . . , N) is a signal on each order after decision.

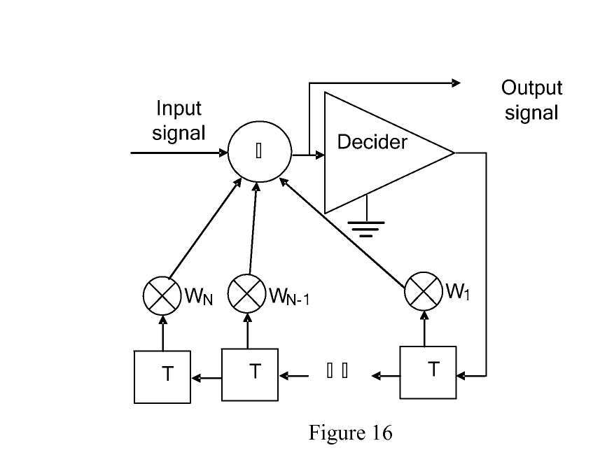

According to the above formula, a Finite Impulse Response (FIR) filter structure includes a shift register group, a coefficient group W, a multiplier, and an adder. FIG. 16 is a block diagram of equalization based on a DFE model in an embodiment of the present disclosure. In this DFE model, the feedback signal is subtracted from all or part of the incoming signal to obtain the final output signal. The feedback structure part inputs the output signal into a decider for deciding, and inputs the decided signal into the shift register group where the signal undergoes N-order delay (N is a serial number of order of the DFE model). The delay T is the reciprocal of the signal baud rate, and the FIR filter multiplies the coefficient group W by the voltage signal stored in the shift register group to obtain a product, and adds up the products in all groups to obtain the final feedback signal. The output signal may serve as a response signal or part of a response signal.
3. CTE model:

The CTE model is used to simulate the equalization function of the CTE circuit in the SERDES receiving chip 31. The CTE model may be expressed by the following filter formula:

$${H}_{CTE} ( f ) = a \frac{{P}_{1} \times … {P}_{N} ( s + {Z}_{1} ) … ( s + {Z}_{N} )}{{Z}_{1} \times … {Z}_{N} ( s + {P}_{1} ) … ( s + {P}_{N} )}$$

wherein, Pᵢ (i=1, . . . , N) is a pole point,
Zᵢ(i=1, . . . , N) is a zero point,
α is CTE gain.

According to the above formula, the CTE model may be a zero-point and a pole-point filter. The zero point Zᵢ and the pole point Pᵢ may be adjusted according to the equalization features. For example, the frequency response of the CTE model is adjusted by adjusting the zero point and pole point. After the zero point and pole point are determined, the above formula is a transfer function of the CTE equalizer model. According to the signal and system principles, after the transfer function and the input signal characteristics of the system based on the CTE model are determined, a convolution algorithm may be used to calculate the output signal derived from the input signal through the system based on this model. The input signal may be all or part of the incoming signal; and the output signal may be all or part of the response signal.

It should be noted that, in the above three equalization models, equalization parameters need to be set to simulate the equalization function of the SERDES receiving chip 31. In the practical application, the equalization parameters corresponding to the working state of the system in the actual environment can be set into the three equalization models. Depending on the equalization circuit in the actual SERDES receiving chip 31, one or a combination of the three models may be applied to the system in order to simulate the equalization function of the equalization circuit correctly.
Scenario 2:

The simulating device 32 is adapted to simulate the equalization of the equalization circuit in the SERDES receiving chip 31 for the incoming signal in the frequency response characteristics mode. The frequency response characteristics model in the simulating device 32 may be described through the tabular data which includes necessary description information such as frequency, amplitude, and phase (or other equivalent description information such as real part, virtual part, or dB phase information). The work process of the frequency response characteristics model in the simulating device 32 is: importing a frequency response data table into the frequency response characteristics model, extrapolating zero frequency data, mirroring frequency extension (for example, performing negative frequency extension for the data), performing the inverse Fourier Transform on the combination of the positive frequency data and the negative frequency data to obtain an impulse response; and convoluting the input incoming signal and the impulse response to obtain a balanced response signal.

It should be noted that the LFE, DFE, CTE models and the frequency response characteristics model mentioned above are maturely available in the prior art. For details of implementing such models, refer to the prior art description.

FIG. 4 shows the structure of an embodiment of a signal measurement system, supposing that the system includes an SERDES receiving chip, an oscilloscope, and a simulating device for simulating the equalization function in the SERDES receiving chip. In order to allow for the impact caused by the packages, junction capacitors, and clamp diodes in an SERDES receiving chip onto the measurement result of the equalized signal, simulation of chip input/output feature is added into the signal measurement system. The simulation is implemented by an Input/Output Buffer Information Specification (IBIS) function entity in the embodiment. As shown in FIG. 4, the structure of the signal measurement system includes an SERDES receiving chip 41, a simulating device 42, and an oscilloscope 43. The simulating device 42 includes an IBIS processing unit 421, and an equalization simulating unit 422. The connection relations and functions of the units are described below:

The SERDES receiving chip 41 is connected with the simulating device 42, the simulating device 42 is connected with the oscilloscope 43, and the IBIS processing unit 421 is connected with the equalization simulating unit 422.

The IBIS processing unit 421 is adapted to process the incoming signal in IBIS operation, simulate equalization, and generate a response signal, for example, simulate equalization for the incoming signal which has undergone an IBIS process to obtain a response signal to be measured. The equalization model may be one or a combination of the LFE model, DFE model, and CTE model, or a frequency response characteristics model, which is described in the prior art. The IBIS process is described below:

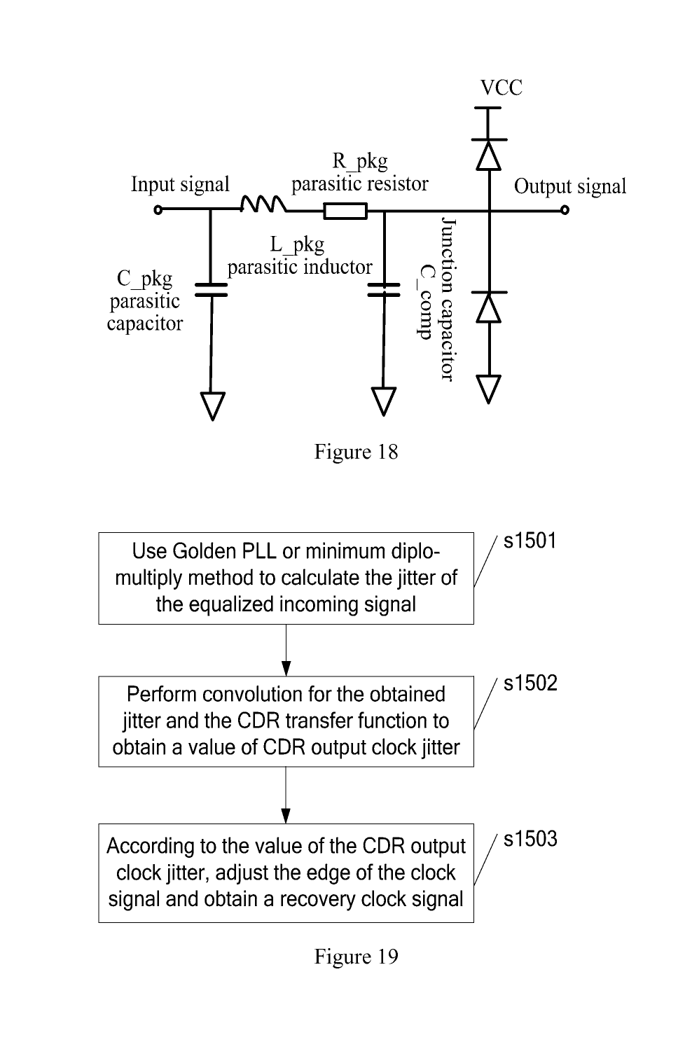

An IBIS input model may be set up. The model includes: a packaged parasitic capacitor, a packaged parasitic inductor, a packaged parasitic resistor, a junction capacitor, an upper-level clamp diode, and lower-level clamp diode. The structure is shown in FIG. 18. A mature and detailed algorithm is provided by the IBIS standard for handling the IBIS model. Therefore, the input model may be the resistor inductor capacitor model in the standard, or an S parameter model. More particularly, the electric feature of a clamp diode may be described through a VI table (V stands for voltage and I stands for current) of the traditional IBIS, or through hardware languages such as Very High Speed Integrated Circuit Hardware Description Language—Analog & Mixed-Signal (VHDL-AMS) or Analog & Mixed-Signal Extensions to Verilog HDL (Verilog-AMS) stipulated in the latest IBIS standard.

The working of an equalization simulating unit 422 may be the same as, but is not limited to, the simulation of the equalization in the simulating device 32 mentioned above.

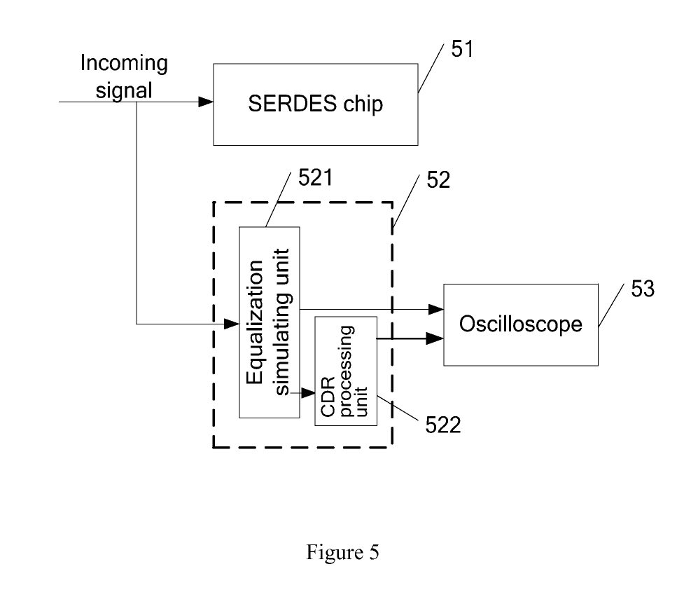

FIG. 5 shows the structure of an embodiment of a signal measurement system, supposing that the system includes an SERDES receiving chip, an oscilloscope, and a simulating device for simulating the equalization function in the SERDES receiving chip. In order to improve the accuracy of the measurement result of the equalized signal, a Clock and Data Recovery (CDR) function is added. As shown in FIG. 5, the system includes an SERDES receiving chip 51, a simulating device 52, and an oscilloscope 53. The simulating device 52 includes an equalization simulating unit 521, and a CDR processing unit 522. The connection relations and functions of the units are described below:

The SERDES receiving chip 51 is connected with the simulating device 52, the simulating device 52 is connected with the oscilloscope 53, and the equalization simulating unit 521 is connected with the CDR processing unit 522.

The equalization simulating unit 521 is adapted to simulate equalization for the incoming signal. The equalization model may be one of or a combination of the LFE model, DFE model, and CTE model, or a frequency response characteristics model, as described above.

The CDR processing unit 522 performs CDR processing, and generates a recovery clock signal, for example, performs CDR operation for the response signal obtained from simulation of equalization, thus obtaining a recovery clock signal which makes the measurement more accurate. The CDR process is described below:

A CDR model may be set up for the purpose of generating recovery clock signal of data recovery. The process of setting up a CDR model to obtain the recovery clock signal is: using a Golden Phase Locked Loop (PLL) algorithm or a minimum diplo-multiply method to calculate the jitter of the equalized incoming signal; processing the obtained jitter and the CDR transfer function in the way of convolution to obtain a value of the CDR output clock jitter; according to the value of the CDR output clock jitter, adjusting the edge of the clock signal to obtain a recovery clock signal.

After the operation of the foregoing unit, the combination of the recovery clock signal and the response signal derived from simulation of equalization is output to the oscilloscope 53.

In the oscilloscope 53, the recovery clock signal is preferred for displaying the response signal, including the output of the signal characteristics such as a time domain waveform chart, eye chart, statistic eye chart, and bathtub curve.

It should be noted that in this system, an IBIS processing model may be added to reduce influence from a packages, junction capacitors and clamp diodes, as illustrated in FIG. 4.

The embodiment of a signal measurement method is hereinafter described in detail with reference to accompanying drawings.

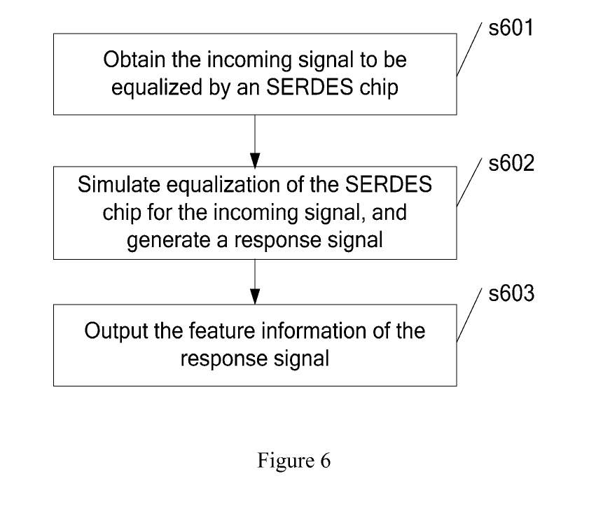

FIG. 6 is a brief flow chart of the embodiment of a signal measurement method. The process includes:

Step s601: Obtaining the incoming signal to be equalized by the SERDES receiving chip.

Step s602: The simulating device simulates SERDES receiving chip equalization for the incoming signal, and generates a response signal. The simulating device may apply the equalization mode in the SERDES receiving chip, for example, use an equalizer model applied in the SERDES receiving chip (for example, the aforementioned one or a combination of the LFE, DFE or CTE equalizer formula models, or a model with the equalizer frequency response characteristics) to equalize the measured incoming signal, and generate an equalized signal as a response signal.

Step s603: The signal feature output device outputs the feature information of the response signal, for example, displays the features of the equalized signal. The features of an equalized signal may be displayed in the form of signal time domain waveforms, eye charts, statistic eye charts, or bathtub curves.

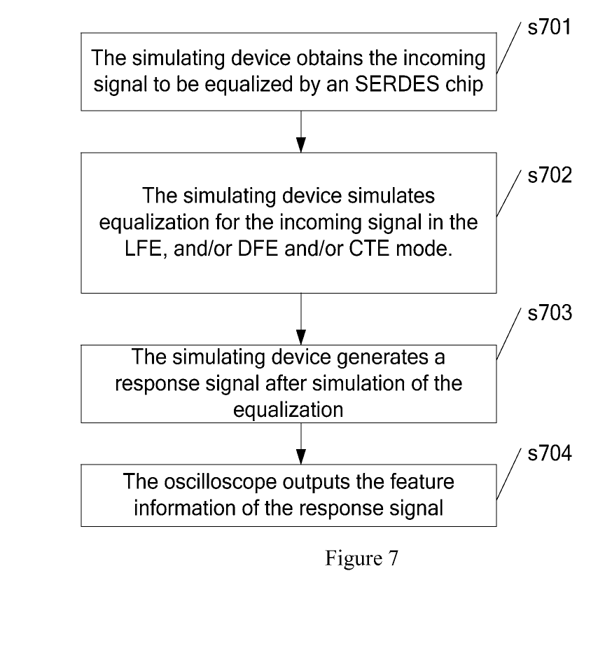

FIG. 7 is a flowchart of an embodiment of a signal measurement method, supposing that the system includes an SERDES receiving chip, an oscilloscope, and a simulating device for simulating the equalization function in the SERDES receiving chip. The process includes:

Step s701: The simulating device obtains the incoming signal to be equalized by the SERDES receiving chip.

Step s702: The simulating device simulates the equalization for the incoming signal in the SERDES receiving chip in the LFE, and/or DFE, and/or CTE processing mode. There are three processing modes:

A. If an LFE model is applied, the LFE model includes: a shift register group, a coefficient group W, a multiplier, and an adder, to make up an FIR filter structure. The filter formula is as follows:

V(T₀)=W₁*Vᵢₙ(T₀)+W₂*Vᵢₙ(T₋₁)+ . . . +W_{N}*Vᵢₙ(T_{N-1})

The process is that all or part of the incoming signal is input into the shift register group for performing N-order delay (N is a serial number of order of the LFE model). When the SERDES receiving chip equalizes in the same mode, the order “N” may be the same as the order of the shift register in the SERDES receiving chip. The delay T is the reciprocal of the signal baud rate, and the FIR filter multiplies the coefficient group W by the voltage signal stored in the shift register group to obtain a product, and adds up the products in every group to obtain the final output signal. The final output signal may serve as a response signal or part of it.

B. If a DFE model is applied, the DFE model includes: a shift register group, a coefficient group W, a multiplier, and an adder, to make up an FIR filter structure. The filter formula is as follows:

V(T₀)=Vᵢₙ(T₀)−W₁*D(T₋₁)−W₂*D(T₋₂)- . . . -W_{N}*D(T_{-N})

The process is: the feedback signal is subtracted from all or part of the incoming signal to obtain the final output signal. The feedback structure part inputs the output signal into a decider for deciding, and inputs the decided signal into the shift register group where the signal undergoes N-order delay (N is a serial number of order of the DFE model). The delay T is the reciprocal of the signal baud rate, and the filter structure multiplies the coefficient group W by the voltage signal stored in the shift register group to obtain a product, and adds up the products in every group to obtain a feedback signal. The output signal may serve as a response signal or part of it.

C. If a CTE model is applied, the formula may be:

$${H}_{CTE} ( f ) = a \frac{{P}_{1} \times … {P}_{N} ( s + {Z}_{1} ) … ( s + {Z}_{N} )}{{Z}_{1} \times … {Z}_{N} ( s + {P}_{1} ) … ( s + {P}_{N} )}$$

According to the above formula, the CTE model is a zero-point and pole-point filter. The zero point Zᵢ and the pole point Pᵢ may be adjusted according to the equalization features. For example, the frequency response of the CTE model is adjusted by adjusting the zero point and pole point. After the zero point and pole point are determined, the above formula is a transfer function of the CTE equalizer model. According to the signal and system principles, after the transfer function and the input signal characteristics of the system based on the CTE model have been determined, a convolution algorithm may be used to calculate the output signal derived from the input signal through the system based on this model. The input signal may be all or part of the incoming signal; and the output signal may be all or part of the response signal.

It should be noted that, in the above three equalization models, equalization parameters need to be set to simulate the equalization function of the SERDES receiving chip. In some embodiments, the equalization parameters corresponding to the working state of the system in the actual environment can be set into the three equalization models. Depending on the equalization circuit in the SERDES receiving chip, one or a combination of the three models may be applied to the system in order to simulate the equalization function of the equalization receiving circuit correctly.

Step s703: The simulating device generates a response signal after simulation of the equalization.

Step s704: The oscilloscope outputs the feature information of the response signal.

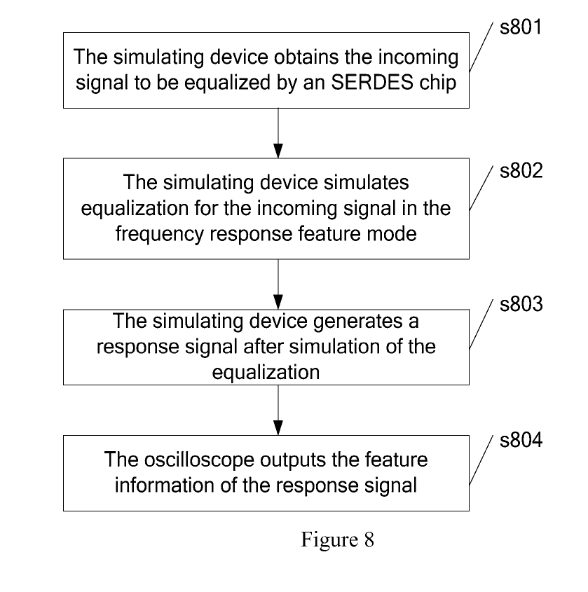

FIG. 8 is a flowchart of an embodiment of a signal measurement method, supposing that the system includes an SERDES receiving chip, an oscilloscope, and a simulating device for simulating the equalization function in the SERDES receiving chip. FIG. 8 differs from FIG. 7 in that: a frequency response characteristics mode is used as a simulation of equalization mode applied in step s8O2. The process includes:

Step s801: The simulating device obtains the incoming signal to be equalized by the SERDES receiving chip.

Step s802: The simulating device simulates the equalization for the incoming signal in the frequency response characteristics mode. The constructed frequency response characteristics model may be described through tabular data which includes necessary description information such as frequency, amplitude, and phase (or other equivalent description information such as real part, virtual part, or dB phase information).

Step s803: The simulating device outputs a response signal after simulation of the equalization.

Step s804: The oscilloscope outputs the feature information of the response signal, for example, outputs the features such as the time domain waveform chart, eye chart, statistic eye chart and bathtub curve of the signals obtained after simulation of equalization.

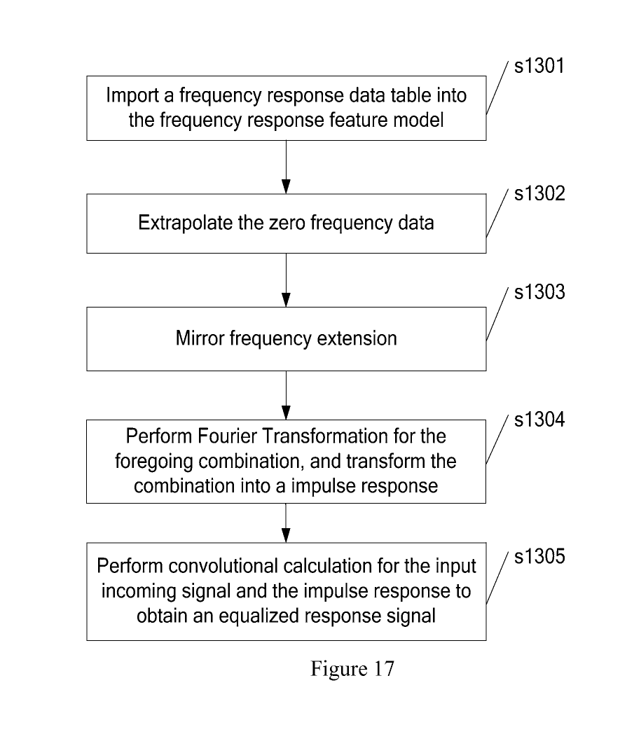

For the equalization process of frequency response characteristics model in step s802, refer to the equalization process of the frequency response characteristics mode shown in FIG. 17 herein. The equalization process includes the following steps:

Step s1301: Importing a frequency response data table into the frequency response characteristics model.

Step s1302: Extrapolating the zero frequency data. Generally, the frequency response data is positive frequency data. In order to facilitate signal calculation, when the lowest frequency is not a zero frequency, extrapolation of zero frequency data is required, for example, extrapolating the frequency to the zero point, thus obtaining the amplitude and phase of the zero frequency.

Step s1303: Mirroring frequency extension, for example, performing negative frequency extension for the data, and combining the positive frequency data with the negative frequency data.

Step s1304: Performing Fourier Transformation for the foregoing combination, and transforming the combination into an impulse response.

Step s1305: Performing convolution calculation for the input incoming signal and the impulse response to obtain an equalized response signal.

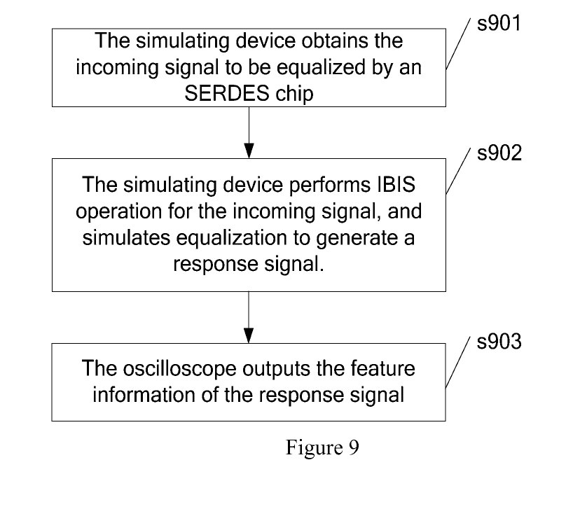

FIG. 9 is a flow chart of an embodiment of a signal measurement method, supposing that the system includes an SERDES receiving chip, an oscilloscope, and a simulating device for simulating the equalization function of the equalization circuit in the SERDES receiving chip. In order to allow for the influence caused by the packages, junction capacitors and clamp diodes in the SERDES receiving chip onto the signal measurement result, an IBIS function is added. The process includes:

Step s901: The simulating device obtains the incoming signal to be equalized by the SERDES receiving chip.

Step s902: The simulating device performs IBIS operation for the incoming signal, simulates equalization, and generates a response signal, for example, simulates equalization for the incoming signal which has undergone an IBIS process to obtain a response signal to be measured. The equalization model may be one of or a combination of the LFE model, DFE model, and CTE model, or a frequency response characteristics model. The IBIS operation may be performed according to the IBIS standard in the prior art after an IBIS input model is constructed, wherein the IBIS input model includes: a packaged parasitic capacitor, a packaged parasitic inductor, a package parasitic resistor, a junction capacitor, an upper-level clamp diode, and a lower-level clamp diode, which will not be described here any further.

Step s903: The oscilloscope outputs the feature information of the response signal, for example, outputs the features such as the time domain waveform chart, eye chart, statistic eye chart and bathtub curve of the signals obtained after simulation of equalization.

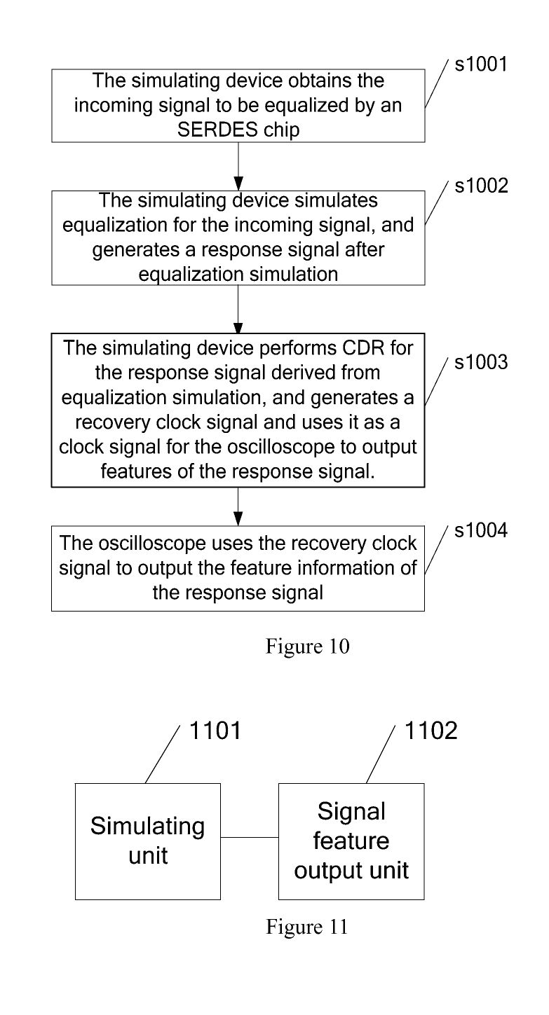

FIG. 10 is a flowchart of the fourth embodiment of a signal measurement method, supposing that the system includes an SERDES receiving chip, an oscilloscope, and a simulating device for simulating the equalization function in the SERDES receiving chip. In order to improve the accuracy of the measurement result of the equalized signal, a CDR function is added. As shown in FIG. 10, the process includes:

Step s1001: The simulating device obtains the incoming signal to be equalized by the SERDES receiving chip.

Step s1002: The simulating device simulates equalization of the SERDES receiving chip for the incoming signal, and generates a response signal after simulation of equalization.

Step s1003: The simulating device performs CDR for the response signal obtained after simulation of equalization, generates a recovery clock signal, and uses the recovery clock signal as a clock signal of output response signal feature for the oscilloscope. The equalization mode may be one of or a combination of the LFE mode, DFE mode, and CTE mode mentioned above, or a frequency response characteristics mode, which will not be repeated here any further.

Step s1004: The oscilloscope adopts the recovery clock signal, and outputs the feature information of the response signal, for example, outputs the features such as the time domain waveform chart, eye chart, statistic eye chart and bathtub curve of the signals obtained after simulation of equalization.

In step s1003, the process of obtaining a recovery clock signal through the CDR model is shown in FIG. 19, and includes the following steps:

Step s1501: Golden PLL or minimum diplo-multiply method is adapted to calculate the jitter of the equalized incoming signal.

Step s1502: The convolution algorithm is performed for the obtained jitter and the CDR transfer function to obtain a value of CDR output clock jitter.

Step s1503: According to the value of the CDR output clock jitter, the edge of the clock signal is adjusted to obtain a recovery clock signal.

It should be noted that the foregoing CDR operation process may be added into the process including IBIS operation shown in FIG. 9.

FIG. 11 shows the structure of an embodiment of a signal measurement device. The signal measurement device includes a simulating unit 1101 and a signal feature output unit 1102. The connection relation and functions of the units are described below:

The simulating unit 1101 is connected with the signal feature output unit 1102;

The SERDES receiving chip equalizes the incoming signal.

The simulating unit 1101 is adapted to obtain an incoming signal, simulate equalization for the incoming signal, and generate a response signal. The simulating unit 1101 may apply the equalization mode in the SERDES receiving chip, for example, use an equalizer model applied in the SERDES receiving chip (for example, the aforementioned one or a combination of the LFE, DFE and CTE equalizer formula models, or a model with the equalizer frequency response characteristics) to equalize the incoming measured signal, generate an equalized signal as a response signal, and output the response signal to the signal feature output unit 1102; and

The signal feature output unit 1102 is adapted to output the feature information of the response signal, for example, display the features of the equalized signal. The features of an equalized signal may be displayed in the form of signal time domain waveforms, eye charts, statistic eye charts, or bathtub curves.

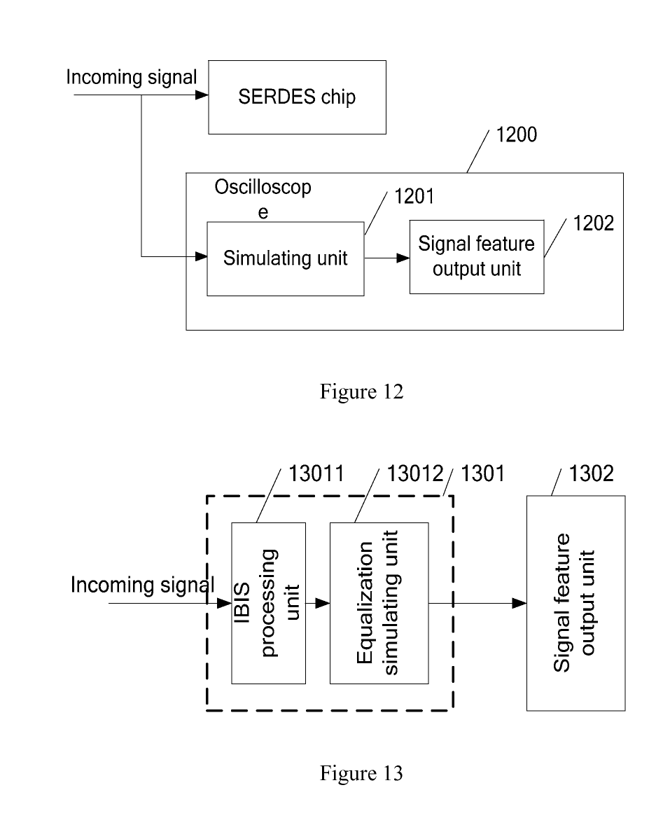

FIG. 12 shows the structure of a first embodiment of a signal measurement device, supposing that the device is an oscilloscope for simulating the equalization circuit in the SERDES receiving chip. The structure of the oscilloscope 1200 includes a simulating unit 1201 and a signal feature output unit 1202. The connection relation and the functions of the units are described below:

The simulating unit 1201 is connected with the signal feature output unit 1202;

The simulating unit 1201 is applied in two scenarios under an embodiment: Scenario 1:

The simulating unit 1201 is adapted to simulate equalization for the incoming signal in one or a combination of the LFE mode, DFE mode, and CTE mode. In the practical implementation, the models corresponding to the equalization modes are described below:
1. LFE model:

The LFE model is used to simulate the equalization function of the LFE circuit in the SERDES receiving chip. The LFE model may be expressed by the following filter formula:

V(T₀)=W₁*Vᵢₙ(T₀)+W₂*Vᵢₙ(T₋₁)+ . . . + W_{N}*Vᵢₙ(T_{N-1})

According to the above formula, a Finite Impulse Response (FIR) filter structure includes a shift register group, a coefficient group W, a multiplier, and an adder. FIG. 15 is a block diagram of equalization based on an LFE model in an embodiment of the present disclosure. In this LFE model, the shift register group inputs all or part of the incoming signals and performs N-order delay CN is a serial number of order of the LFE model). When the SERDES receiving chip equalizes in such a mode, the order “N” may be the same as the order of the shift register in the SERDES receiving chip. The delay T is the reciprocal of the signal baud rate, and the FIR filter multiplies the coefficient group W by the voltage signal stored in the shift register group to obtain a product, and adds up the products in every group to obtain the final output signal. The final signal may serve as a response signal or part of it.
2. DFE model:

The DFE model is used to simulate the equalization function of the DFE circuit in the SERDES receiving chip. The DFE model may be expressed by the following filter formula:

V(T₀)=Vᵢₙ(T₀)−W₁*D(T₋₁)−W₂*D(T₋₂)- . . . -W_{N}*D(T_{-N})

According to the above formula, a Finite Impulse Response (FIR) filter structure includes a shift register group, a coefficient group W, a multiplier, and an adder. FIG. 16 is a block diagram of equalization based on a DFE model in an embodiment of the present disclosure. In this DFE model, the feedback signal is subtracted from all or part of the incoming signal to obtain the final output signal. The feedback structure part inputs the output signal into a decider for deciding, and inputs the decided signal into the shift register group where the signal undergoes N-order delay (N is a serial number of order of the DFE model). The delay T is the reciprocal of the signal baud rate, and the FIR filter multiplies the coefficient group W by the voltage signal stored in the shift register group to obtain a product, and adds up the products in every group to obtain the final feedback signal. The output signal may serve as a response signal or part of it.
3. CTE model:

The CTE model is used to simulate the equalization function of the CTE circuit in the SERDES receiving chip. The LFE model may be expressed by the following filter formula:

$${H}_{CTE} ( f ) = a \frac{{P}_{1} \times … {P}_{N} ( s + {Z}_{1} ) … ( s + {Z}_{N} )}{{Z}_{1} \times … {Z}_{N} ( s + {P}_{1} ) … ( s + {P}_{N} )}$$

According to the above formula, the CTE model may be a zero-point and pole-point filter. The zero point Zᵢ and the pole point Pᵢ may be adjusted according to the equalization features. For example, the frequency response of the CTE model is adjusted by adjusting the zero point and pole point. After the zero point and pole points are determined, the above formula is a transfer function of the CTE equalizer model. According to the signal and system principles, after the transfer function and the input signal characteristics of the system based on the CTE model are determined, a convolution algorithm may be used to calculate the output signal derived from the input signal through the system based on this model. The input signal may be all or part of the incoming signal; and the output signal may be all or part of the response signal.

It should be noted that, in the above three equalization models, equalization parameters need to be set into simulate the equalization function of the SERDES receiving chip. In the application, the equalization parameters corresponding to the working state of the system in the environment can be set into the three equalization models. Depending on the equalization circuit in the SERDES receiving chip, one or a combination of the three models may be applied to the system in order to simulate the equalization function of the equalization circuit correctly.
Scenario 2:

The simulating unit 1201 is adapted to simulate the equalization of the equalization circuit in the SERDES receiving chip for the incoming signal in the frequency response characteristics mode. The frequency response characteristics model in the simulating unit 1201 may be described through the tabular data which includes necessary description information such as frequency, amplitude, and phase (or other equivalent description information such as real part, virtual part, or dB phase information). The work process of the frequency response characteristics model in the simulating device 1201 is: importing a frequency response data table into the frequency response characteristics model, extrapolating zero frequency data, mirroring frequency extension (for example, performing negative frequency extension for the data), performing the inverse Fourier Transform on the combination of the positive frequency data and the negative frequency data to obtain an impulse response; and convoluting the input incoming signal and the impulse response to obtain a balanced response signal.

It should be noted that the LFE, DFE, CTE models and the frequency response characteristics model mentioned above are maturely available in the prior art. For details of implementing such models, refer to the prior art description.

FIG. 13 shows the structure of an embodiment of a signal measurement device, supposing that the device is an oscilloscope for simulating the equalization function in an SERDES receiving chip. In order to allow for the influence caused by the packages, junction capacitors, and clamp diodes in an SERDES receiving chip onto the measurement result of the equalized signal, simulation of chip input/output feature is added into the oscilloscope. The simulation is implemented by an Input/Output Buffer Information Specification (IBIS) function entity in the embodiment. As shown in FIG. 13, the structure of the oscilloscope includes a simulating unit 1301, and a signal feature output unit 1302. The simulating unit 1301 includes an IBIS processing unit 13011 and an equalization simulating unit 13012. The connection relations and functions of the units are described below:

The simulating unit 1301 is connected with the signal feature output unit 1302, and the IBIS processing unit 13011 is connected with the equalization simulating unit 13012.

The IBIS processing unit 13011 is adapted to perform IBIS operation for the incoming signal, simulate equalization, and generate a response signal, for example, simulate equalization for the incoming signal which has undergone an IBIS process to obtain a response signal to be measured. The equalization model may be one or a combination of LFE, DFE, and CTE models, or a frequency response characteristics model, which is described in the prior art. The IBIS process is described below:

An IBIS input model may be set up. The model includes: a packaged parasitic capacitor, a packaged parasitic inductor, a packaged parasitic resistor, a junction capacitor, an upper-level clamp diode, and lower-level clamp diode. The structure is shown in FIG. 18. A mature and detailed algorithm is provided by the IBIS standard for handling the IBIS model. Therefore, the input model may be the resistor inductor capacitor model in the standard, or the S parameter model. More particularly, the electric features of a clamp diode may be described through a VI table (V stands for voltage and I stands for current) of the traditional IBIS, or through hardware languages such as Very High Speed Integrated Circuit Hardware Description Language—Analog & Mixed-Signal (VHDL-AMS) or Analog & Mixed-Signal Extensions to Verilog HDL (Verilog-AMS) stipulated in the latest IBIS standard.

The working of an equalization simulating unit 13012 may be the same as, but is not limited to, the simulation of the equalization in the simulating unit 1201 mentioned above.

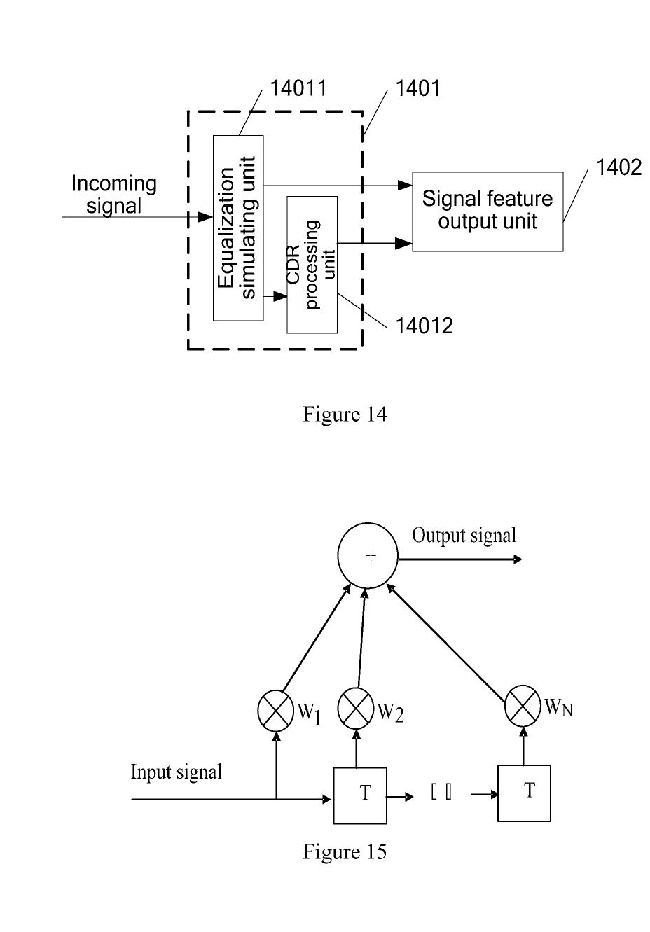

FIG. 14 shows the structure of an embodiment of a signal measurement device, supposing that the device is an oscilloscope for simulating the equalization function in the SERDES receiving chip. In order to improve the accuracy of the measurement result of the equalized signal, a CDR function is added into the oscilloscope. The structure of the oscilloscope includes a simulating unit 1401, and a signal feature output unit 1402. The simulating unit 1401 includes an equalization simulating unit 14011 and a CDR processing unit 14012. The connection relations and the functions of the units are described below:

The simulating unit 1401 is connected with the signal feature output unit 1402, and the equalization simulating unit 14011 is connected with the CDR processing unit 14012.

The equalization simulating unit 14011 is adapted to simulate equalization for the incoming signal. The equalization model may be one or a combination of the LFE model, DFE model, and CTE model, or a frequency response characteristics model, as described above.

The CDR processing unit 14012 performs CDR processing, and generates a recovery clock signal, for example, performs CDR operation for the response signal obtained from simulation of equalization, thus obtaining a recovery clock signal which makes the measurement more accurate. The CDR process is described below:

A CDR model may be set up for the purpose of generating clock information of data recovery. The process of setting up a CDR model to obtain a recovery clock signal is: using a Golden Phase Locked Loop (PLL) algorithm or a minimum diplo-multiply method to calculate the jitter of the equalized incoming signal; performing convolution for the obtained jitter and the CDR transfer function to obtain a value of the CDR output clock jitter; according to the value of the CDR output clock jitter, adjusting the edge of the clock signal to obtain a recovery clock signal.

After the processing of the foregoing unit, the combination of the recovery clock signal and the response signal derived from simulation of equalization is output to the signal feature output unit 1402 for displaying.

In the signal feature output unit 1402, the recovery clock signal is preferred for displaying the features of the response signal, including the output of the signal characteristics such as the time domain waveform chart, eye chart, statistic eye chart, and bathtub curve.

It should be noted that in the signal processing device, an IBIS processing model may be added to reduce impact on the packages, junction capacitors and clamp diodes, as illustrated in FIG. 13.

The foregoing oscilloscope may be replaced with other signal feature output devices such as spectrum analyzer and a computer capable of outputting signal characteristics. The measurement point may be the position of the corresponding pin of the chip to which the incoming signal is input.

Although the invention has been described through preferred exemplary embodiments, the invention is not limited to such embodiments. It is apparent that those skilled in the art can make various modifications and variations to the invention without departing from the spirit and scope of the invention. The invention is intended to cover the modifications and variations provided that they fall in the scope of protection defined by the claims or their equivalents.

1. A system for measuring signals, comprising:
a simulating device, adapted to obtain an incoming signal to be equalized by an SERDES receiving chip, simulate equalization for the incoming signal, and generate a response signal, and
a signal characteristic output device, adapted to output the feature information of the response signal.

2. The system for measuring signals according to claim 1, wherein, the simulate equalization comprises:
simulating the equalization for the incoming signal by adopting one or a combination of LFE, DFE and CTE equalizer models, or a model with equalizer frequency response characteristics.

3. The system for measuring signals according to claim 1, wherein, the simulating device comprises:
an IBIS processing unit, adapted to perform IBIS simulating operation for the incoming signal; and
an equalization simulating unit, adapted to simulate equalization for the incoming signal which has undergone an IBIS process to obtain a response signal, wherein the model of the equalization may be one of or a combination of the LFE, DFE, and CTE models, or a model with equalizer frequency response characteristics.

4. The system for measuring signals according to claim 1, wherein, the simulating device further comprises:
a CDR processing unit, adapted to perform CDR processing for the response signal obtained from the equalization simulating unit, and generate a recovery clock signal which serves as clock signal of the signal characteristic output device.

5. The system for measuring signals according to claim 1, wherein,
the signal characteristic output device is an oscilloscope or a computer; the feature information comprises one or a combination of the time domain waveform chart, eye chart, statistic eye chart, and bathtub curve.

6. A method for measuring signals, comprising:
obtaining an incoming signal to be equalized by an SERDES receiving chip;
simulating SERDES receiving chip equalization for the incoming signal, and generating a response signal;
outputting the feature information of the response signal.

7. The method for measuring signals according to claim 6, wherein, the simulating SERDES receiving chip equalization for the incoming signal, comprises:
simulating the equalization for the incoming signal by adopting one or a combination of LFE, DFE and CTE equalizer models, or a model with equalizer frequency response characteristics.

8. The method for measuring signals according to claim 6, wherein, the simulating SERDES receiving chip equalization for the incoming signal, comprises:
performing IBIS simulating operation for the incoming signal; and
simulating equalization for the incoming signal which has undergone an IBIS process to obtain a response signal, wherein the equalization model may be one or a combination of the LFE, DFE, and CTE models, or the model with the equalizer frequency response characteristics.

9. The method for measuring signals according to claim 6, wherein, the simulating SERDES receiving chip equalization for the incoming signal, further comprises:
performing CDR processing for the response signal obtained from the equalization simulating unit, and generating a recovery clock signal, which serves as a clock signal of the output feature information of the response signal.

10. The method for measuring signals according to claim 6, wherein, the feature information comprises one or a combination of the time domain waveform chart, eye chart, statistic eye chart, and bathtub curve.

11. An equipment for measuring signals, comprising:
a simulating unit, adapted to obtain an incoming signal to be equalized by an SERDES receiving chip, simulate equalization for the incoming signal, and generate a response signal, and
a signal characteristic output unit, adapted to output the feature information of the response signal.

12. The equipment for measuring signals according to claim 11, wherein, the simulate equalization comprises:
simulating the equalization for the incoming signal by adopting one or a combination of LFE, DFE and CTE equalizer models, or a model with equalizer frequency response characteristics.

13. The equipment for measuring signals according to claim 11, wherein, the simulating unit comprises:
an IBIS processing unit, adapted to perform IBIS simulating operation for the incoming signal; and
an equalization simulating unit, adapted to simulate equalization for the incoming signal which has undergone an IBIS process to obtain a response signal, wherein the model of the equalization may be one or a combination of the LFE, DFE, and CTE models, or the model with the equalizer frequency response characteristics.

14. The system for measuring signals according to claim 11, wherein, the simulating device further comprises:
a CDR processing unit, adapted to perform CDR processing for the response signal obtained from the equalization simulating unit, and generate a recovery clock signal which serves as clock signal of the signal characteristic output unit.

15. The system for measuring signals according to claim 11, wherein,
the signal characteristic output unit is an oscilloscope or a computer; the feature information comprises one or a combination of the time domain waveform chart, eye chart, statistic eye chart, and bathtub curve.
